(19) United States
(12) Patent Application Publication
(10) Pub. No.: US 2018/0182319 A1
(43) Pub. Date: Jun. 28, 2018

(54) LIQUID CRYSTAL DISPLAY AND ARRAY SUBSTRATE THEREOF

(71) Applicant: Wuhan China Star Optoelectronics Technology Co., Ltd., Wuhan, Hubei (CN)

(72) Inventor: Guowei ZHA, Shenzhen, Guangdong (CN)

(73) Assignee: Wuhan China Star Optoelectronics Technology Co., Ltd., Wuhan, Hubei (CN)

(21) Appl. No.: 15/311,607

(22) PCT Filed: Oct. 9, 2016
(86) PCT No.: PCT/CN2016/101528

§ 371 Date: Nov. 16, 2016

(30) Foreign Application Priority Data
Aug. 24, 2016 (CN) 201610717712.4

(51) Int. Cl. G09G 3/36

(52) U.S. Cl. CPC G09G 3/3607; G09G 3/3688; G09G 2300/0452; G09G 2320/0209; G09G 3/3677

(57) ABSTRACT

A liquid crystal display and its array substrate are disclosed. The array substrate includes a number of scan lines, a number of data lines, and a number of pixels arranged in an array. Each pixel includes four sub-pixels disposed in two lines and two columns. The four sub-pixels are red, green, blue, and white sub-pixels. Each sub-pixel is connected to a thin film transistor (TFT). The TFTs are driven by the data and scan lines. Any two sub-pixels of a same color on two neighboring lines and on two neighboring columns have reversed polarities.

### BACKGROUND OF THE INVENTION

### 1. Field of the Invention

The present disclosure relates to display devices, and in particular to a liquid crystal display and an array substrate of the liquid crystal display.

### 2. The Related Arts

Thin film transistor liquid crystal display (TFT-LCD) is currently the most popular type of display device due to its simplicity, low heat production, long operational life, and comfortable viewing, etc. Among TFT-LCDs, RGBW (red, green, blue, white) four-color TFT-LCD is a widely accepted one. For this type of display, when a single-color image block (such as a red block) is displayed, all pixels of the block have data voltages of a same polarity during line inversion. The coupling effect between the data voltages and the common voltage therefore cannot be mutually cancelled, leading to cross-talk phenomenon.

### SUMMARY OF THE INVENTION

To obviate the shortcomings of the prior art, the present disclosure teaches a liquid crystal display (LCD) of a better display quality and an array substrate of the LCD.

The array substrate includes a number of scan lines, a number of data lines, and a number of pixels arranged in an array. Each pixel includes four sub-pixels disposed in two lines and two columns. The four sub-pixels are red, green, blue, and white sub-pixels. Each sub-pixel is connected to a thin film transistor (TFT). The TFTs are driven by the data and scan lines. Any two sub-pixels of a same color on two neighboring lines and on two neighboring columns have reversed polarities.

In addition, each column of sub-pixels is disposed between two neighboring scan lines. For sub-pixels along a same column, the TFTs for those on odd-numbered lines are connected to the respective scan lines beneath the TFTs, and the TFTs for those on even-numbered lines are connected to the respective scan lines above the TFTs. Each line of sub-pixels is disposed between two neighboring data lines. For sub-pixels along a same line, the TFTs for those on odd-numbered columns are connected to the respective scan lines to the left of the TFTs, and the TFTs for those on even-numbered columns are connected to the respective scan lines to the right of the TFTs. Any two neighboring data lines have reversed polarities.

In addition, each line of sub-pixels includes neighboring red, green, blue, and white sub-pixels.

In addition, each column of sub-pixels includes neighboring red, green, blue, and white subpixels.

The LCD includes the above-described array substrate.

In addition, the LCD further includes a line inversion data driving circuit connected to the data lines.

In addition, the LCD further includes gate scan circuit connected to the scan lines.

Since any two sub-pixels of a same color on two neighboring lines and on two neighboring columns have reversed polarities, cross-talk is prevented and a better display quality is guaranteed.

### BRIEF DESCRIPTION OF THE DRAWINGS

To make the technical solution of the embodiments according to the present disclosure, a brief description of the drawings that are necessary for the illustration of the embodiments will be given as follows. Apparently, the drawings described below show only example embodiments of the present disclosure and for those having ordinary skills in the art, other drawings may be easily obtained from these drawings without paying any creative effort. In the drawings:

FIG. 1 is a functional block diagram showing a liquid crystal display according to the present disclosure; and

FIG. 2 is a schematic diagram showing an array substrate of a liquid crystal display according to an embodiment of the present disclosure.

### DETAILED DESCRIPTION OF THE PREFERRED EMBODIMENTS

In the following embodiments of the present disclosure are explained in details along with the accompanied drawings.

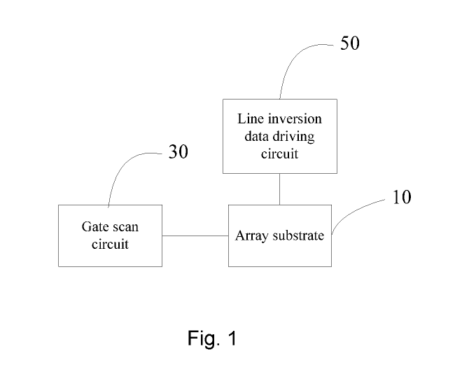

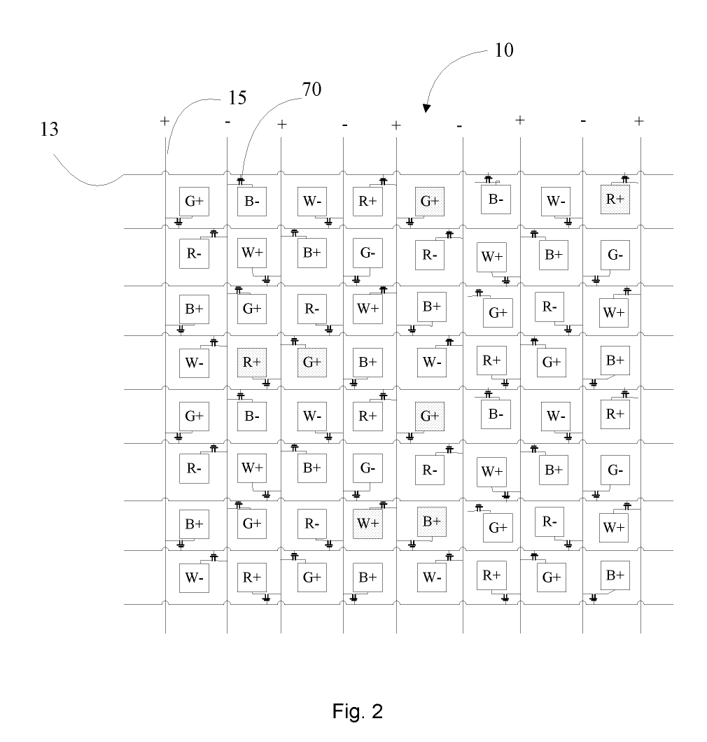

As shown in FIGS. 1 and 2, a liquid crystal display (LCD) includes an array substrate 10, a gate scan circuit 30, and a line inversion data driving circuit 50.

The array substrate 10 includes multiple pixels 11 arranged in an array. Each pixel 11 includes four sub-pixels arranged in two lines and two columns. The four sub-pixels includes a red sub-pixel, a green sub-pixel, a blue sub-pixel, and a white sub-pixel. In the present embodiment shown in FIG. 2, there are four pixels 11 along each line and each column.

The array substrate 10 also includes multiple data lines 13 and scan lines 15. Any two neighboring data lines 13 have reversed polarities. The data lines 13 are connected to the line inversion data driving circuit 50. The scan lines 15 are connected to the gate scan circuit 30. Each line of sub-pixels is disposed between two neighboring data lines 13. Each scan line 15 corresponds to a column of sub-pixels.

Each sub-pixel is connected to a thin film transistor (TFT) 70. Each column of sub-pixels is disposed between two neighboring scan lines 15. For sub-pixels along a same column, the TFTs 70 for those on odd-numbered lines are connected to the respective scan lines beneath the TFTs 70; and the TFTs 70 for those on even-numbered lines are connected to the respective scan lines above the TFTs 70. Each line of sub-pixels is disposed between two neighboring data lines 13. For sub-pixels along a same line, the TFTs 70 for those on odd-numbered columns are connected to the respective scan lines to the left of the TFTs 70; and the TFTs 70 for those on even-numbered columns are connected to the respective scan lines to the right of the TFTs 70. Any two neighboring data lines 13 have reversed polarities. For two sub-pixels of a same color on two neighboring lines and on two neighboring columns have reversed polarities. Within each pixel, each sub-pixel and its neighboring sub-pixels have revered polarities. For each line of sub-pixels, any two neighboring sub-pixels have reversed polarities.

Each line of sub-pixels includes neighboring red, green, blue, and white sub-pixels.

Each column of sub-pixels includes neighboring red, green, blue, and white subpixels. Sub-pixels of a same color on two neighboring lines have reversed polarities.

Since any two sub-pixels of a same color on two neighboring lines and on two neighboring columns have reversed polarities, cross-talk is prevented and a better display quality is guaranteed.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the clams of the present disclosure.

What is claimed is:

1. An array substrate for a liquid crystal display, comprising a plurality of scan lines, a plurality of data lines, and a plurality of pixels arranged in an array, wherein
each pixel comprises four sub-pixels disposed in two lines and two columns;
the four sub-pixels are red, green, blue, and white sub-pixels;
each sub-pixel is connected to a thin film transistor (TFT);
the TFTs are driven by the data and scan lines; and
any two sub-pixels of a same color on two neighboring lines and on two neighboring columns have reversed polarities.

2. The array substrate as claimed in claim 1, wherein each column of sub-pixels is disposed between two neighboring scan lines; for sub-pixels along a same column, the TFTs for those on odd-numbered lines are connected to the respective scan lines beneath the TFTs, and the TFTs for those on even-numbered lines are connected to the respective scan lines above the TFTs; each line of sub-pixels is disposed between two neighboring data lines; for sub-pixels along a same line, the TFTs for those on odd-numbered columns are connected to the respective scan lines to the left of the TFTs, and the TFTs for those on even-numbered columns are connected to the respective scan lines to the right of the TFTs; and any two neighboring data lines have reversed polarities.

3. The array substrate as claimed in claim 1, wherein, for each line of sub-pixels, any two neighboring sub-pixels have reversed polarities; and, within each pixel, each sub-pixel and its neighboring sub-pixels have revered polarities.

4. The array substrate as claimed in claim 2, wherein each line of sub-pixels comprises neighboring red, green, blue, and white sub-pixels.

5. The array substrate as claimed in claim 1, wherein ach column of sub-pixels comprises neighboring red, green, blue, and white subpixels.

6. A liquid crystal display (LCD), comprising an array substrate which comprises a plurality of scan lines, a plurality of data lines, and a plurality of pixels arranged in an array, wherein
each pixel comprises four sub-pixels disposed in two lines and two columns;
the four sub-pixels are red, green, blue, and white sub-pixels;
each sub-pixel is connected to a thin film transistor (TFT);
the TFTs are driven by the data and scan lines; and
any two sub-pixels of a same color on two neighboring lines and on two neighboring columns have reversed polarities.

7. The LCD as claimed in claim 6, wherein each column of sub-pixels is disposed between two neighboring scan lines; for sub-pixels along a same column, the TFTs for those on odd-numbered lines are connected to the respective scan lines beneath the TFTs, and the TFTs for those on even-numbered lines are connected to the respective scan lines above the TFTs; each line of sub-pixels is disposed between two neighboring data lines; for sub-pixels along a same line, the TFTs for those on odd-numbered columns are connected to the respective scan lines to the left of the TFTs, and the TFTs for those on even-numbered columns are connected to the respective scan lines to the right of the TFTs; and any two neighboring data lines have reversed polarities.

8. The LCD as claimed in claim 6, wherein, for each line of sub-pixels, any two neighboring sub-pixels have reversed polarities; and, within each pixel, each sub-pixel and its neighboring sub-pixels have revered polarities.

9. The LCD as claimed in claim 7, wherein each line of sub-pixels comprises neighboring red, green, blue, and white sub-pixels.

10. The array substrate as claimed in claim 6, wherein ach column of sub-pixels comprises neighboring red, green, blue, and white subpixels.

11. The LCD as claimed in claim 6, further comprising a line inversion data driving circuit connected to the data lines.

12. The LCD as claimed in claim 6, further comprising a gate scan circuit connected to the scan lines.
